(19) United States
(12) Patent Application Publication
(10) Pub. No.: US 2025/0261091 A1
(43) Pub. Date: Aug. 14, 2025

(54) SLICE CONTROL OF A WIRELESS COMMUNICATION DEVICE IN A VISITED WIRELESS COMMUNICATION NETWORK

(71) Applicant: T-MOBILE INNOVATIONS LLC, Overland Park, KS (US)

(72) Inventors: Subramania Kaushik, Bellevue, WA (US); Anil Kumar Mariyani, Ashburn, VA (US); Srujana Punyapu, Seattle, WA (US)

(21) Appl. No.: 18/437,937

(22) Filed: Feb. 9, 2024

(51) Int. Cl. H04W 48/16; H04W 84/04

(52) U.S. Cl. CPC H04W 48/16; H04W 84/042

(57) ABSTRACT

A wireless communication system controls a wireless communication device in a visited wireless communication network. A network database stores a slice indicator for a visited wireless network slice in the visited wireless communication network. A network controller receives a request from the visited wireless communication network for the wireless communication device, and in response to receiving the request, the network controller retrieves the slice indicator for the visited wireless communication network from the network database and transfers the slice indicator to the wireless communication device over the visited wireless communication network. The wireless communication device communicates using the visited wireless network slice in the visited wireless communication network in response to receiving the slice indicator.

### TECHNICAL BACKGROUND

Wireless communication networks provide wireless data services to wireless communication devices like phones, computers, and other user devices. The wireless data services may include internet-access, data messaging, video conferencing, or some other data communication product. The wireless communication networks comprise wireless access nodes like Wireless Fidelity (WIFI) hotspots, Fifth Generation New Radio (5GNR) cell towers, and satellites in earth orbit. The different types of wireless access nodes represent different access technologies. The wireless communication networks further comprise network elements the process network signaling and handle user data like Access and Mobility Management Functions, User Plane Functions (UPFs), Unified Data Management (UDMs), and Application Functions (AFs). Different sets of wireless access nodes and network elements represent different Public Land Mobile Networks (PLMNs). Thus, a wireless communication network may offer several types of access technologies and several different PLMNs.

The wireless communication devices are homed to a home wireless communication network. The wireless communication devices use visited wireless communication networks when their home wireless communication network is not available. The visited wireless communication networks communicate with the home wireless communication networks to obtain authorization to serve the visiting wireless communication devices. The visited wireless communication networks also communicate with the home wireless communication networks to obtain instructions on how to serve the visiting wireless communication devices. One such piece of information comprises a network list that instructs the visiting wireless communication devices to select the highest priority access technologies and PLMNs that are available in the visited wireless communication networks. A special network element-called a Steering-of-Roaming AF—is used to serve these network lists to the wireless communication devices over other network elements.

Wireless network slices comprise network elements like UPFs that are customized for specific user applications and network services. The wireless communication devices request the specific wireless network slice for their current user application and network service. The wireless communication networks then deliver this network service using the requested wireless network slice. For example, a wireless communication device may use a low-latency wireless network slice to serve a low-latency user application.

Unfortunately, the use of the SoR AF to serve the network lists does not effectively and efficiently indicate wireless network slices. Moreover, the use of the SoR AF to serve the network lists prevents the delivery of wireless communication services from the preferred wireless network slices in the visited wireless communication networks.

### TECHNICAL OVERVIEW

In some examples, a wireless communication device is controlled in a visited wireless communication network. A slice indicator for a visited wireless network slice in the visited wireless communication network is stored. A request is received from the visited wireless communication network for the wireless communication device, and in response to receiving the request, the slice indicator is retrieved for the visited wireless communication network and transferred to the wireless communication device over the visited wireless communication network. The wireless communication device communicates using the visited wireless network slice in the visited wireless communication network in response to receiving the slice indicator.

In some examples, a wireless communication device is controlled in a visited Public Land Mobile Network (PLMN). A Steering-of-Roaming Application Function (SoR-AF) stores a slice indicator for a visited wireless network slice in the visited PLMN. A Unified Data Management (UDM) receives a request from the visited PLMN for the wireless communication device, and in response to receiving the request, the UDM retrieves the slice indicator for the visited PLMN from the SoR-AF and transfers the slice indicator to the wireless communication device over the visited PLMN. The wireless communication device communicates using the visited wireless network slice in the visited PLMN in response to receiving the slice indicator.

In some examples, a wireless communication system controls a wireless communication device in a visited wireless communication network. A network database stores a slice indicator for a visited wireless network slice in the visited wireless communication network. A network controller receives a request from the visited wireless communication network for the wireless communication device, and in response to receiving the request, the network controller retrieves the slice indicator for the visited wireless communication network from the network database and transfers the slice indicator to the wireless communication device over the visited wireless communication network. The wireless communication device communicates using the visited wireless network slice in the visited wireless communication network in response to receiving the slice indicator.

### DESCRIPTION OF THE DRAWINGS

FIG. 1 illustrates an exemplary data communication system to control a roaming wireless device in a visited wireless network.

FIG. 2 illustrates an exemplary operation of the data communication system to control the roaming wireless device in the visited wireless network.

FIG. 3 illustrates an exemplary operation of the data communication system to control the roaming wireless device in the visited wireless network.

FIG. 4 illustrates exemplary processing circuitry to control roaming wireless devices visited wireless networks.

FIG. 5 illustrates an exemplary wireless communication system to control roaming wireless User Equipment (UEs) in visited wireless communication networks.

FIG. 6 illustrates an exemplary UE in the wireless communication system to control the roaming wireless UEs in the visited wireless communication networks.

FIG. 7 illustrates an exemplary Fifth Generation New Radio (5GNR) access node in the wireless communication system to control the roaming wireless UEs in the visited wireless communication networks.

FIG. 8 illustrates an exemplary Wireless Fidelity (WIFI) access node in the wireless communication system to control the roaming wireless UEs in the visited wireless communication networks.

FIG. 9 illustrates an exemplary satellite access node and ground station in the wireless communication system to control the roaming wireless UEs in the visited wireless communication networks.

FIG. 10 illustrates an exemplary visited wireless communication network in the wireless communication system to control the roaming wireless UEs in the visited wireless communication networks.

FIG. 11 illustrates an exemplary home wireless communication network in the wireless communication system to control the roaming wireless UEs in the visited wireless communication networks.

FIG. 12 illustrates an exemplary operation of the wireless communication system to control the roaming wireless UEs in the visited wireless communication networks.

FIG. 13 illustrates an exemplary operation of the wireless communication system to control the roaming wireless UEs in the visited wireless communication networks.

### DETAILED DESCRIPTION

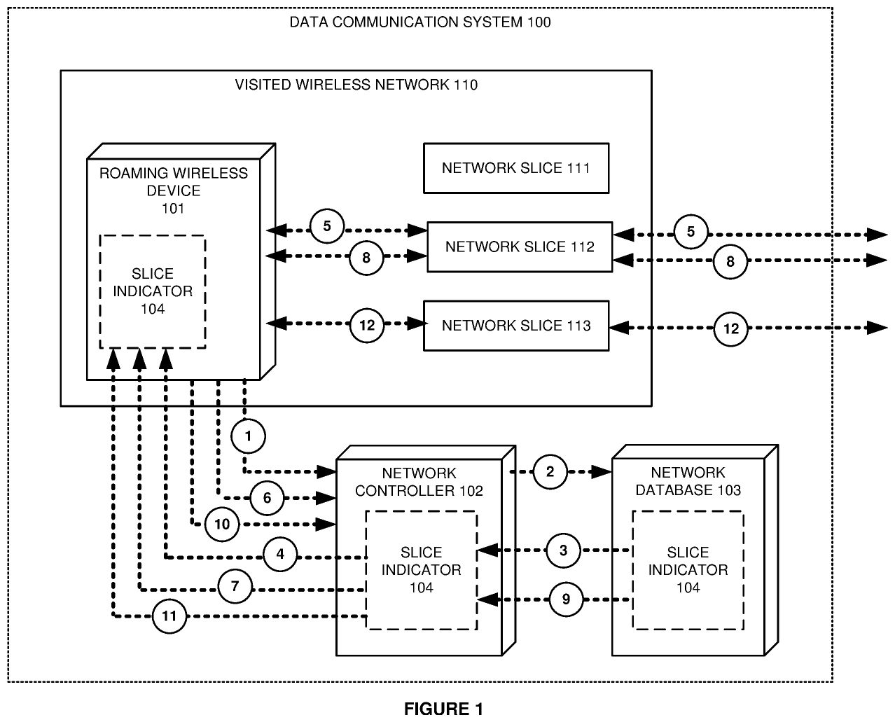

FIG. 1 illustrates exemplary data communication system 100 to control roaming wireless device 101 in visited wireless network 110. Data communication system 100 comprises network controller 102, network database 103, and visited wireless network 110. Visited wireless network 110 comprises roaming wireless device 101 and wireless network slices 111-113. Roaming wireless device 101 comprises a phone, computer, vehicle, sensor, or some other data communication apparatus. Network controller 102 comprises one or more network elements that control the delivery of wireless communication services to user devices like roaming wireless device 101. In some examples, network controller 102 comprises a Unified Data Management (UDM). Network database 103 comprises one or more network elements that store data like slice list 104 to support network controller 102. In some examples, network database 103 comprises a Steering-of-Roaming Application Function (SoR-AF). Network slices 111-113 comprise one or more network elements that process user data for roaming wireless device 101. In some examples, network slices 111-113 comprise User Plane Functions (UPFs). The amount of wireless devices, wireless networks, and network slices that are shown on FIG. 1 has been simplified for clarity of illustration, and is not intended to be limiting.

In some examples, network database 103 stores slice indicator 104 for visited wireless network slice 112 in visited wireless network 110. Slice indicator 104 may comprise a slice type, slice name, slice code, or some other information that roaming wireless device 101 can use to select network slices. Network controller 102 receives a request from the visited wireless network 110 for roaming wireless device 101 (arrow #1). In response to receiving the request, network controller 102 retrieves slice indicator 104 for slice 112 in visited wireless network 110 from network database 103 (arrows #2-3). Network controller 102 transfers slice indicator 104 to roaming wireless device 101 over visited wireless network 110 (arrow #4). Roaming wireless device 101 communicates using visited wireless network slice 112 in visited wireless network 110 in response to receiving slice indicator 104 (arrows #5).

Network controller 102 caches slice indicator 104 for visited wireless network 110 in a controller memory. In response to receiving another request (arrow #6), network controller 102 retrieves cached slice indicator 104 for visited wireless network 110 from the controller memory and transfers cached slice indicator 104 to roaming wireless device 101 over the visited wireless network 110 (arrow #7). Roaming wireless device 101 communicates using wireless network slice 112 in visited wireless network 110 in response to receiving cached slice indicator 104 (arrows #8).

Network database 103 then modifies slice indicator 104 for the visited wireless network 110. For example, old slice indicator 104 that indicates network slice 112 may be changed to indicate network slice 113. In response to the modification, network database 103 transfers modified slice indicator 104 for visited wireless network 110 to network controller 102 (arrow #9). Network controller 102 caches modified slice indicator 104 for visited wireless network 110 in the controller memory. In response to receiving another request (arrow #10), network controller 102 retrieves modified slice indicator 104 for visited wireless network 110 from the controller memory and transfers modified slice indicator to roaming wireless device 101 over the visited wireless network 110 (arrow #11). Roaming wireless device 101 now communicates using wireless network slice 113 in visited wireless network 110 in response to receiving modified slice indicator 104 (arrows #12).

In some examples, network database 103 stores a Public Land Mobile Network Identifier (PLMN ID) for visited wireless network 110 and stores slice indicator 104 in association with the PLMN ID. Network controller 102 receives the request that indicates the PLMN ID from visited wireless network 110. Network controller 102 retrieves slice indicator 104 based on the PLMN ID in the request and the association of the PLMN ID and slice indicator 104 in network database 103.

In some examples, network database 103 stores a user application indicator for visited wireless network 110 and stores slice indicator 104 in association with the user application indicator. The user application indicator is for a user application executing in roaming wireless device 101. Network controller 102 receives the request that indicates the user application indicator from visited wireless network 110. Network controller 102 retrieves slice indicator 104 based on the user application indicator in the request and the association of the user application indicator and slice indicator 104 in network database 103.

In some examples, network database 103 stores an access technology indicator for visited wireless network 110 and stores slice indicator 104 in association with the access technology indicator. The access technology indicator is for network access in visited wireless network 110 like Fifth Generation New Radio (5GNR), Wireless Fidelity (WIFI), communication satellites, and the like. Network controller 102 receives the request that indicates the access technology indicator from visited wireless network 110. Network controller 102 retrieves slice indicator 104 based on the access technology indicator in the request and the association of the access technology indicator and slice indicator 104 in network database 103.

In some examples, network database 103 stores a prioritized slice list that includes slice indicator 104 and additional slice indicators in a priority order. Network controller 102 retrieves the prioritized slice list and transfers the prioritized slice list 104 to roaming wireless device 101 in response to receiving the request. Roaming wireless device 101 then selects and uses the highest-priority network slices based on the prioritized slice list.

Roaming wireless device 101 and visited wireless network 110 comprise radios that wirelessly communicate using wireless protocols like Wireless Fidelity (WIFI), Fifth Generation New Radio (5GNR), Long Term Evolution (LTE), Low-Power Wide Area Network (LP-WAN), Near-Field Communications (NFC), Code Division Multiple Access (CDMA), Frequency Division Multiple Access (FDMA), Time Division Multiple Access (TDMA), and satellite data communications. Roaming wireless device 101, network controller 102, network database 103, visited wireless network 110, and network slices 111-113 comprise microprocessors, software, memories, transceivers, bus circuitry, and/or some other data processing components. The microprocessors comprise Digital Signal Processors (DSP), Central Processing Units (CPU), Graphical Processing Units (GPU), Application-Specific Integrated Circuits (ASIC), and/or some other data processing hardware. The memories comprise Random Access Memory (RAM), flash circuitry, disk drives, and/or some other type of data storage. The memories store software like operating systems, utilities, protocols, applications, and functions. The microprocessors retrieve the software from the memories and execute the software to drive the operation of data communication system 100 as described herein.

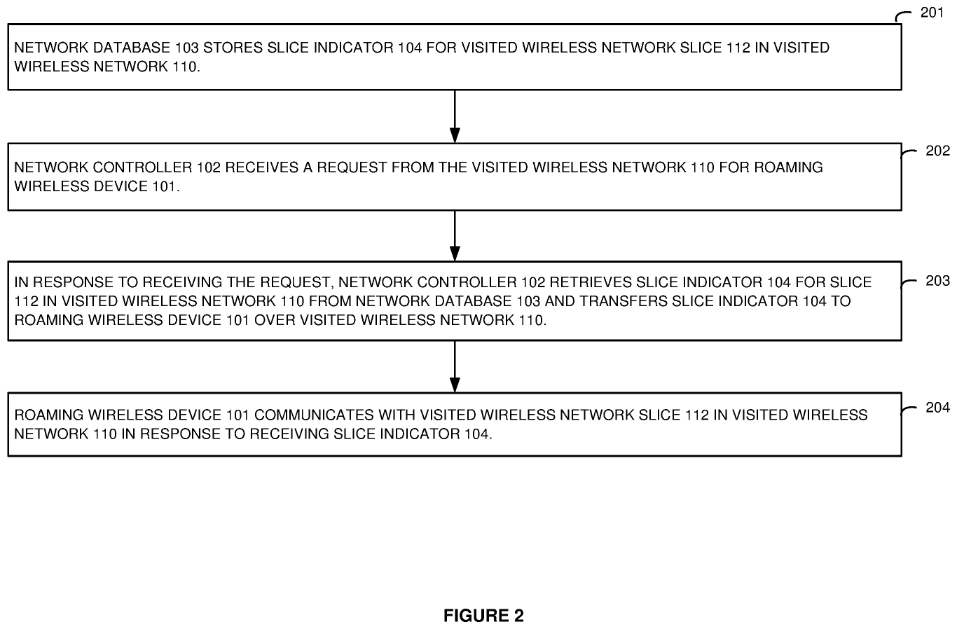

FIG. 2 illustrates an exemplary operation of data communication system 100 to control roaming wireless device 101 in visited wireless network 110. The operation may vary in other examples. Network database 103 stores slice indicator 104 for visited wireless network slice 112 in visited wireless network 110 (201). Network controller 102 receives a request from the visited wireless network 110 for roaming wireless device 101 (202). In response to receiving the request, network controller 102 retrieves slice indicator 104 for slice 112 in visited wireless network 110 from network database 103 and transfers slice indicator 104 to roaming wireless device 101 over visited wireless network 110 (203). Roaming wireless device 101 communicates using visited wireless network slice 112 in visited wireless network 110 in response to receiving slice indicator 104 (204).

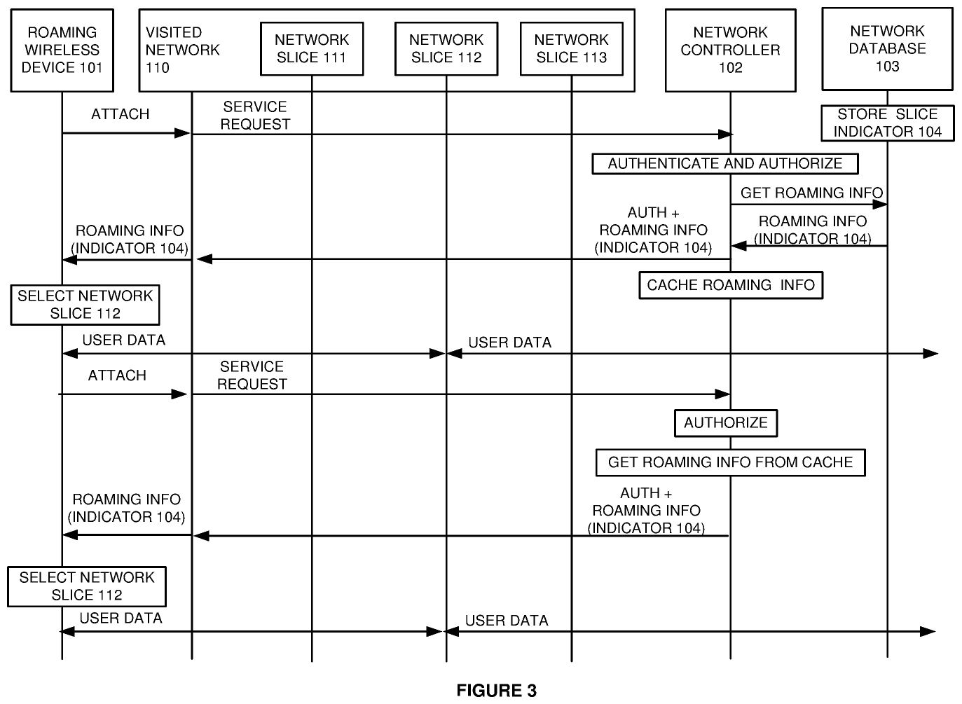

FIG. 3 illustrates an exemplary operation of data communication system 100 to control roaming wireless device 101 in visited wireless network 110. The operation may vary in other examples. Network database 103 stores slice indicator 104 for visited wireless network slice 112 in visited wireless network 110. Roaming user device 101 attaches to visited wireless network 110. Visited wireless network 110 transfers a service request to network controller 102 for roaming wireless device 101. In response to receiving the request, network controller 102 authenticates and authorizes roaming wireless device 101. Network controller 102 retrieves roaming information for visited wireless network 110 from network database 103. The roaming information includes slice indicator 104 and typically other data like preferred networks and access technologies. Network controller 110 transfers an authorization (AUTH) and the roaming information which includes slice indicator 104 to visited wireless network 110. Visited wireless network 110 transfers the roaming information which includes slice indicator 104 to roaming wireless device 101. Roaming wireless device 101 selects wireless network slice 112 based on slice indicator 104. Roaming wireless device 101 communicates using visited wireless network slice 112 in visited wireless network 110 in response to receiving slice indicator 104. Network controller also caches the roaming information which includes slice indicator 104 in a controller cache memory.

Roaming user device 101 subsequently attaches to visited wireless network 110. Visited wireless network 110 transfers a service request to network controller 102 for roaming wireless device 101. In response to receiving the request, network controller 102 authenticates and authorizes roaming wireless device 101. Network controller 102 retrieves roaming information for visited wireless network 110 from its cache memory and not from network database 103. The roaming information includes slice indicator 104 and typically other data like preferred networks and access technologies. Network controller 110 transfers an authorization and the roaming information which includes slice indicator 104 to visited wireless network 110. Visited wireless network 110 transfers the roaming information which includes slice indicator 104 to roaming wireless device 101. Roaming wireless device 101 selects wireless network slice 112 based on slice indicator 104. Roaming wireless device 101 communicates using visited wireless network slice 112 in visited wireless network 110 in response to receiving slice indicator 104.

Advantageously, network controller 102 serves network list 104 that effectively and efficiently indicates wireless network slices. Moreover, the use of network list 104 enables the delivery of wireless communication services from the preferred network slices in the visited wireless communication network 110.

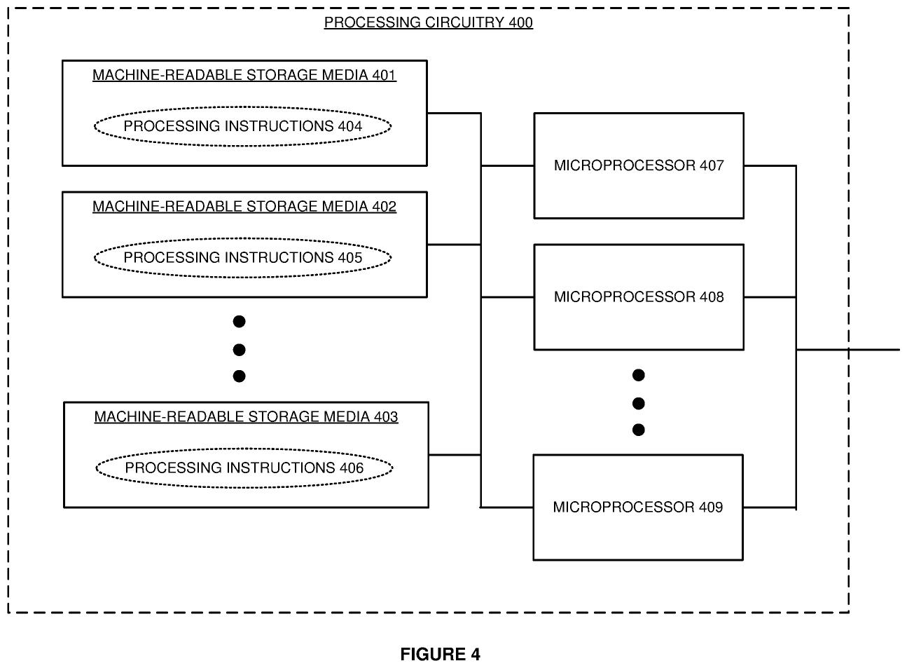

FIG. 4 illustrates exemplary processing circuitry 400 to control roaming wireless devices in visited wireless networks. Processing circuitry 400 comprises an example of roaming wireless device 101, network controller 102, network database 103, and visited wireless network 110, although device 101, controller 110, database 103, and network 110 may differ. Processing circuitry 400 comprises machine-readable storage media 401-403 and microprocessors 407-409 that are communicatively coupled. Machine-readable storage media 401-403 store processing instructions 404-406 in a non-transitory manner. Microprocessors 407-409 comprise DSPs, CPUs, GPUs, ASICs, and/or some other data processing hardware. Machine-readable storage media 401-403 comprises RAM, flash circuitry, disk drives, and/or some other type of data storage apparatus. Microprocessors 407-409 retrieve processing instructions 404-406 from non-transitory machine-readable storage media 401-403. Microprocessors 407-409 execute processing instructions 404-406 to control roaming wireless devices in visited wireless networks as described above for data communication system 100 and as described below for wireless communication network 500. The amount of storage media, microprocessors, processing instructions that are shown in FIG. 4 may vary in other examples.

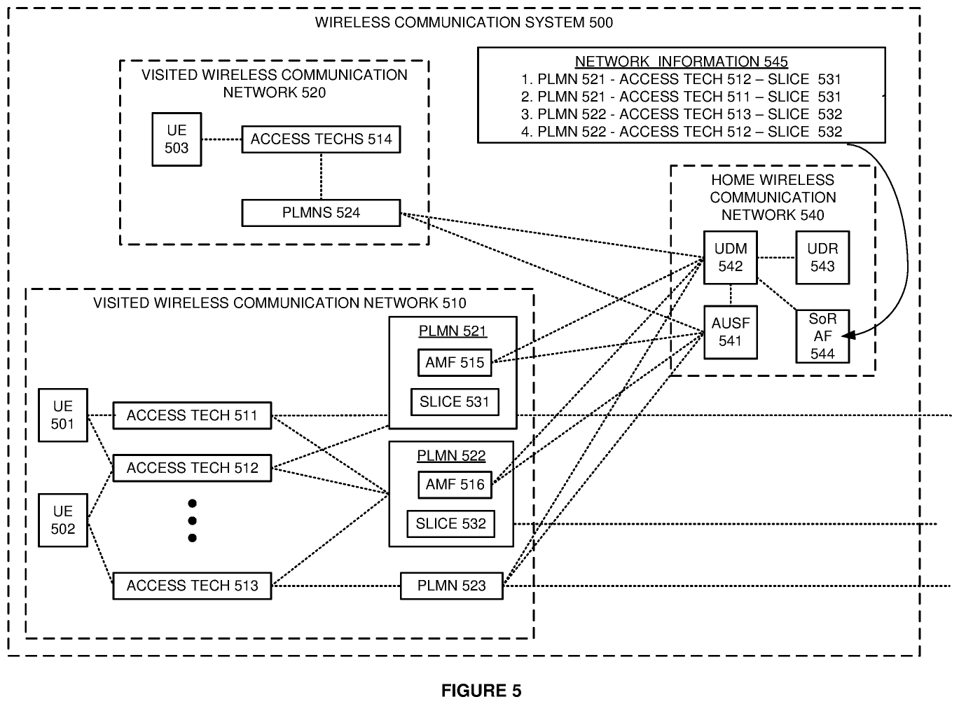

FIG. 5 illustrates exemplary wireless communication system 500 to control roaming wireless User Equipment (UEs) 501-503 in visited wireless communication networks 510 and 520. Wireless communication system 500 comprises an example of data communication system 100 and processing circuitry 400, although system 100 and circuitry 400 may differ. Wireless communication system 500 comprises visited wireless communication network 510, visited wireless communication network 520, and home wireless communication network 530. Visited wireless communication network 510 comprises User Equipment (UE) 501-502, access technologies 511-513, and Public Land Mobile Networks (PLMNs) 521-523. PLMN 521 comprises Access and Mobility Management Function (AMF) 515 and slice 531. PLMN 522 comprises AMF 516 and slice 532. Home wireless communication network 530 comprises Authorization Server Function (AUSF) 541, Unified Data Management (UDM) 542, Unified Data Repository (UDR) 543, and Steering-of-Roaming Application Function (SoR AF) 544. Visited wireless communication network 520 comprises UE 503, access technologies 514 and PLMNs 524. PLMNs 521-524 comprise additional slices for selection by UEs 501-503, but the amount of slices shown on FIG. 5 is simplified for clarity of illustration, and is not intended to be limiting.

SoR AF 544 stores network information (NET INFO) 545 for visited wireless communication network 510 and home wireless communication network 530. Network information 545 indicates prioritized networks, access technologies, and slices for UEs that are homed to home wireless communication network 530 but that are visiting visited wireless communication network 510. PLMN 521, access technology 512, and slice 531 have the highest priority. PLMN 521, access technology 511, and slice 531 have the second highest priority. PLMN 522, access technology 513, and slice 532 have the third highest priority. PLMN 522, access technology 512, and slice 532 have the fourth highest priority.

UE 501 is visiting wireless communication network 510 and is homed to wireless communication network 530. UE 501 initially attaches to access technology 511 (a 5GNR access node). UE 501 transfers a registration request to AMF 515 over access technology 511. AMF 515 transfers an authentication request to AUSF 541. AUSF 541 transfers the authentication request to UDM 542 which interacts with UDR 543 to obtain and generate authentication data for UE 501. UDM 542 transfers the authentication data to AUSF 541. AUSF 541 transfers the authentication data to AMF 515. AMF 515 and UE 501 perform an authentication session over access technology 511.

After UE authentication, AMF 515 transfers a User Equipment Context Management (UECM) registration to UDM 542. UDM 542 queries UDR 543 for context for UE 501. UDM 542 transfers a UECM registration OK message to AMF 515. AMF 515 transfers a Subscriber Data Management GET message to UDM 542. UDM 542 queries UDR 543 for subscriber data for UE 501. UDM 542 transfers a UECM registration OK message to AMF 515. UDM 542 detects that UE 501 is roaming on PLMN 521 in network 510 based on these SDM interactions, and in response, transfers Steering-of-Roaming request to SoR AF 544. SoR AF 544 identifies SoR information for visited wireless communication network 510 which includes network information 545. SoR AF 544 transfers an SoR response to UDM 542 that incudes network information 545. UDM 542 caches network information 545 for PLMN 521 in visited wireless communication network 510.

UDM 542 transfers an SoR protection request to AUSF 541, and AUSF 541 returns an SoR protection response. After SoR protection is established, UDM 542 transfers an SoR response to AMF 515 that includes network information 545. AMF 515 transfers a registration accept message that includes network information 545 to UE 501 over access technology 511. UE 501 selects the highest priority network and access based on network information 545—access technology 512, PLMN 521, and slice 531. UE 501 establishes service and exchanges data over access technology 512, PLMN 521, and slice 531.

Subsequently, UE 501 attaches to access technology 512. UE 501 transfers a registration request to AMF 515 over access technology 512. AMF 515 transfers an authentication request to AUSF 541. AUSF 541 transfers the authentication request to UDM 542 which interacts with UDR 543 to obtain and generate authentication data for UE 501. UDM 542 transfers the authentication data to AUSF 541. AUSF 541 transfers the authentication data to AMF 515. AMF 515 and UE 501 perform an authentication session over access technology 512.

After UE authentication, AMF 515 transfers a UECM registration to UDM 542. UDM 542 queries UDR 543 for context for UE 501. UDM 542 transfers a UECM registration OK message to AMF 515. AMF 515 transfers an SDM GET message to UDM 542. UDM 542 queries UDR 543 for subscriber data for UE 501. UDM 542 transfers a UECM registration OK message to AMF 515. UDM 542 detects that UE 501 is roaming on PLMN 521 in visited network 510 based on the SDM interactions, and in response, retrieves network information 545 for PLMN 521 in visited network 510 from its cache. Note that UDM 542 does not need retrieve network information 545 from SoR AF 544.

UDM 542 transfers an SoR protection request to AUSF 541, and AUSF 541 returns an SoR protection response. After SoR protection is established, UDM 542 transfers an SoR response to AMF 515 that includes network information 545. AMF 515 transfers a registration accept message that includes network information 545 to UE 501 over access technology 512. UE 501 selects the highest priority network, access technology, and slice based on network information 545—access tech 512, PLMN 521, and slice 531. UE 501 establishes service and exchanges data over access technology 512, PLMN 521, and slice 531.

Subsequently, network information 545 is modified in SoR AF 544. For example, network information 545 may be modified to list PLMN 522 and slice 532 as higher priorities than PLMN 521 and slice 531. In response to the modification, SoR AF 544 transfers modified network information 545 to UDM 542. UDM 542 caches modified network information 545 for PLMN 521 in visited wireless network 510 in place of old network information 545. As described above for old network information 545, UDM 542 will retrieve modified network information 545 from its cache without accessing SoR AF 544 and will transfer modified network information 545 to UE 501 when UE 501 visits PLMN 521 in wireless communication network 510. UE 501 will use modified network information 545 to select the highest priority PLMN, slice, and access technology. In this example, UE 501 will use modified network information 545 to switch to PLMN 522 and slice 532 instead of PLMN 521 and slice 531.

UE 502 is also in visited wireless communication network 510 and is homed to home wireless communication network 530. The above operation that was used above for UE 501 would also be used for UE 502—except that UDM 542 would use cached network information 545 from its cache for UE 502 if network information 545 is already available in the cache.

UE 503 is in visited wireless communication network 520 and is homed to home wireless communication network 530. The above operation that was used above for UE 501 would also be used for UE 503 except that UDM 542 typically uses different network information for PLMNs 524 visited wireless communication network 520.

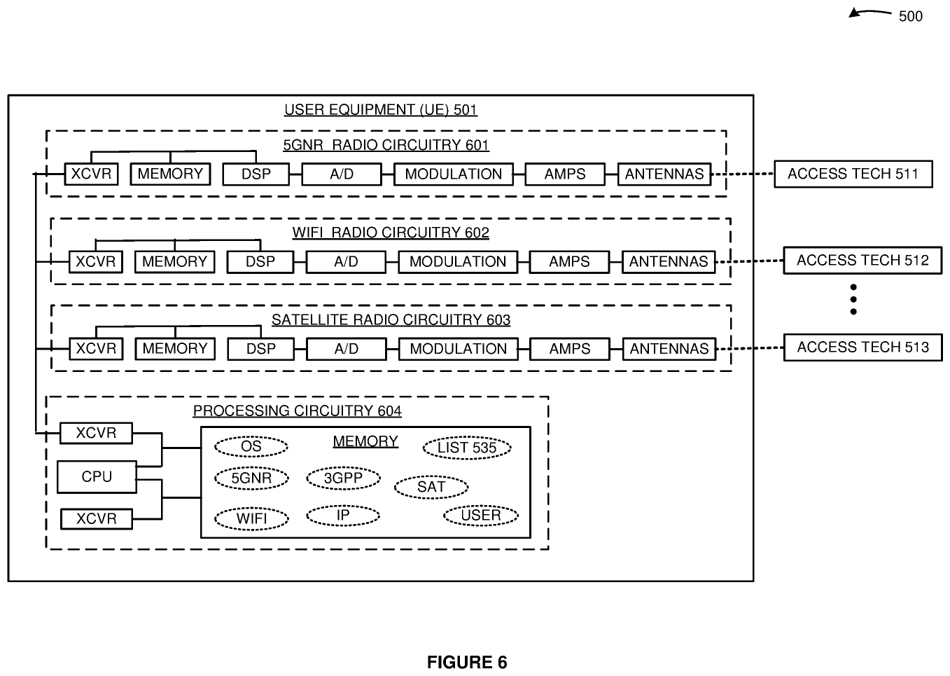

FIG. 6 illustrates exemplary UE 501 in wireless communication system 500 to control roaming wireless UEs 501-503 in visited wireless communication networks 510 and 520. UE 501 comprises an example of roaming wireless device 101, although device 101 may differ. UEs 502-503 could be similar. UE 501 comprises Fifth Generation New Radio (5GNR) radio circuitry 601, Wireless Fidelity (WIFI) radio circuitry 602, satellite radio circuitry 603, and processing circuitry 604. Radio circuitry 601-603 comprises antennas, amplifiers, filters, modulation, analog-to-digital interfaces, DSPs, memories, and transceivers (XCVRs) that are coupled over bus circuitry. Processing circuitry 604 comprises one or more CPUs, one or more memories, and one or more transceivers that are coupled over bus circuitry. The one or more memories in processing circuitry 604 store software like an Operating System (OS), 5GNR Application (5GNR), 3GPP Application (3GPP), WIFI Application (WIFI), Satellite Application (SAT), Internet Protocol application (IP), and eventually, network information 545. The antennas in radio circuitry 601-603 exchange wireless signals with access technologies 511-513. Transceivers in radio circuitry 601-603 are coupled to transceivers in processing circuitry 604. In processing circuitry 604, the one or more CPUs retrieve the software from the one or more memories and execute the software to direct the operation of UE 501 as described herein. For example, the CPU may execute the 3GPP app along with network information 545 to select the highest priority PLMNs, slices, and access technologies for visited wireless communication network 510.

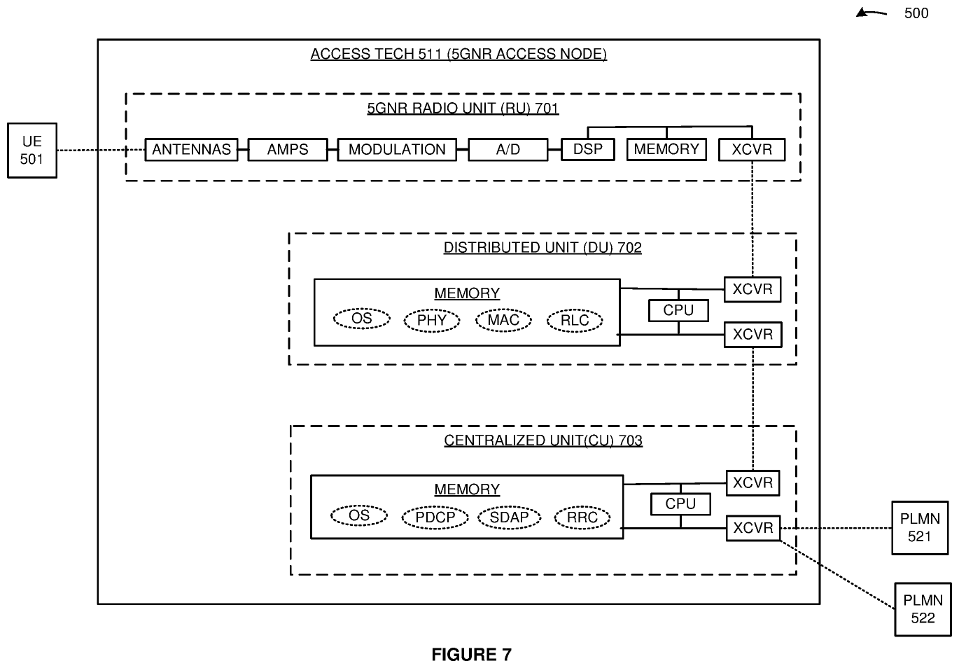

FIG. 7 illustrates exemplary access technology 511 (a Fifth Generation New Radio (5GNR) access node) in wireless communication system 500 to control roaming wireless UEs 501-503 in visited wireless communication networks 510 and 520. The 5GNR access node comprises an example of visited wireless network 110 and processing circuitry 400, although network 110 and circuitry 400 may differ. The 5GNR access node comprises 5GNR Radio Unit (RU) 701, Distributed Unit (DU) 702, and Centralized Unit (CU) 703. 5GNR RU 701 comprises antennas, amplifiers, filters, modulation, analog-to-digital interfaces, DSP, memory, radio applications, and transceivers that are coupled over bus circuitry. DU 702 comprises memory, CPU, user interfaces and components, and transceivers that are coupled over bus circuitry. The memory in DU 702 stores operating system and 5GNR network applications for Physical Layer (PHY), Media Access Control (MAC), and Radio Link Control (RLC). CU 703 comprises memory, CPU, and transceivers that are coupled over bus circuitry. The memory in CU 703 stores an operating system and 5GNR network applications for Packet Data Convergence Protocol (PDCP), Service Data Adaption Protocol (SDAP), and Radio Resource Control (RRC). The antennas in 5GNR RU 701 are wirelessly coupled to UE 501 over 5GNR links. Transceivers in 5GNR RU 701 are coupled to transceivers in DU 702. Transceivers in DU 702 are coupled to transceivers in CU 703. Transceivers in CU 703 are coupled to transceivers in PLMNs 521-522. The DSP and CPU in RU 701, DU 702, and CU 703 execute the radio applications, operating systems, and network applications to exchange data and signaling between UE 501 and PLMNs 521-522 as described herein.

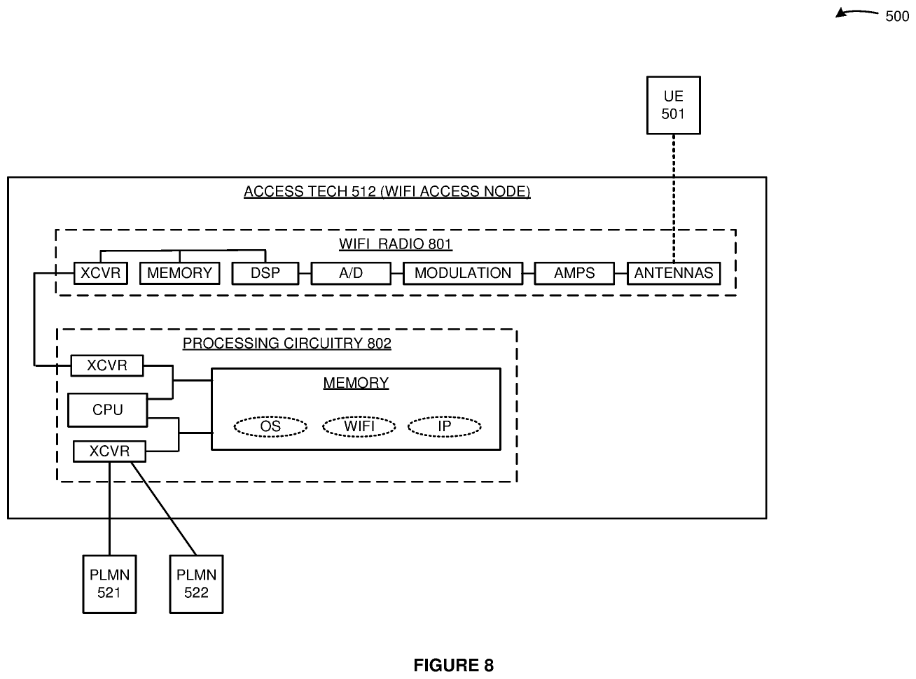

FIG. 8 illustrates exemplary access technology 512 (a Wireless Fidelity (WIFI) access node) in wireless communication system 500 to control roaming wireless UEs 501-503 in visited wireless communication networks 510 and 520. The WIFI access node comprises an example of visited wireless network 110 and processing circuitry 400, although network 110 and circuitry 400 may differ. The WIFI access node comprises WIFI radio 801 and processing circuitry 802. Radio 801 comprises antennas, amplifiers, filters, modulation, analog-to-digital interfaces, DSPs, memories, and transceivers that are coupled over bus circuitry. Processing circuitry 802 comprises one or more CPUs, one or more memories, and one or more transceivers that are coupled over bus circuitry. The one or more memories in processing circuitry 802 store software like an Operating System (OS), WIFI application (WIFI), and IP application (IP). The antennas in WIFI radio 801 exchange WIFI signals with UE 501. Transceivers in radio 801 are coupled to transceivers in processing circuitry 802. Transceivers in processing circuitry 802 are coupled to transceivers in PLMNs 521-522. In processing circuitry 802, the one or more CPUs retrieve the software from the one or more memories and execute the software to exchange data and signaling between UE 501 and PLMNs 521-522 as described herein.

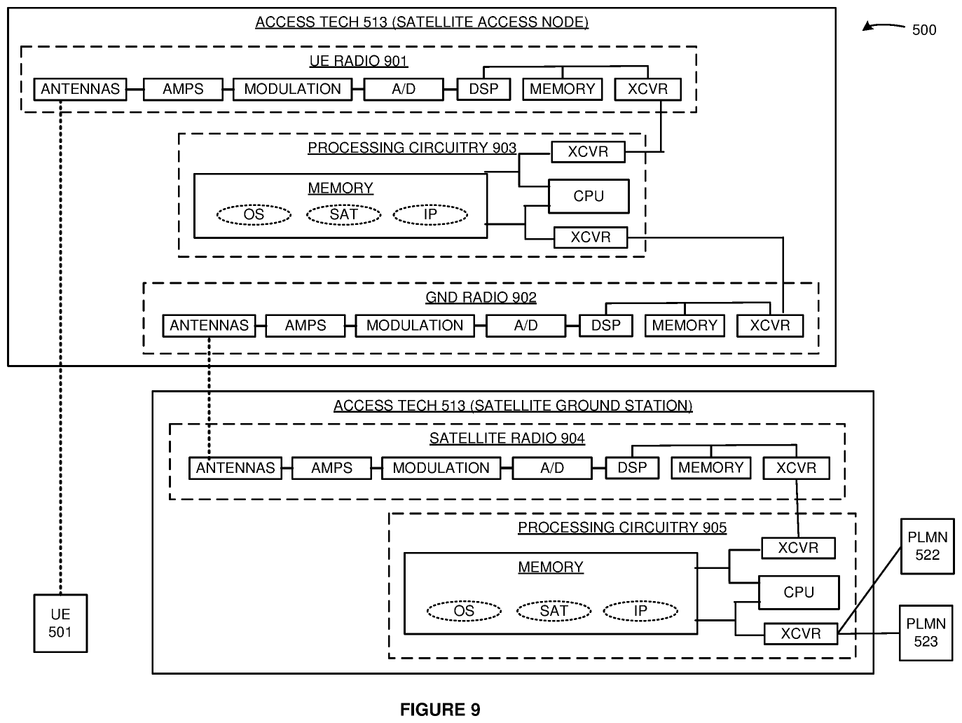

FIG. 9 illustrates exemplary access technology 513 (a satellite access node and satellite ground station) in wireless communication system 500 to control roaming wireless UEs 501-503 in visited wireless communication networks 510 and 520. The satellite access node and satellite ground station comprise examples of visited wireless network 110 and processing circuitry 400, although network 110 and circuitry 400 may differ. The satellite access node comprises UE radio 901, GND radio 902 and processing circuitry 903. The satellite ground station comprises satellite radio 904 and processing circuitry 905. Radios 901-902 and 904 comprise antennas, amplifiers, filters, modulation, analog-to-digital interfaces, DSPs, memories, and transceivers that are coupled over bus circuitry. Processing circuitry 903 and 905 comprise one or more CPUs, one or more memories, and one or more transceivers that are coupled over bus circuitry. The one or more memories in processing circuitry 903 and 905 store software like an Operating System (OS), Satellite Application (SAT), and IP Application (IP). The antennas in UE radio 901 exchange satellite signals with UE 501. Transceivers in UE radio 901 are coupled to transceivers in processing circuitry 903. Transceivers in processing circuitry 903 are coupled to transceivers in GND radio 902. The antennas in GND radio 902 exchange satellite signals with antennas in satellite radio 904, and the antennas in satellite radio 904 exchange the satellite signals with GND radio 902. Transceivers in satellite radio 904 are coupled to transceivers in processing circuitry 905. Transceivers in processing circuitry 905 are coupled to transceivers in PLMNs 522-523. In processing circuitry 903 and 905, the one or more CPUs retrieve the software from the one or more memories and execute the software to exchange data and signaling between UE 501 and PLMNs 522-523 as described herein.

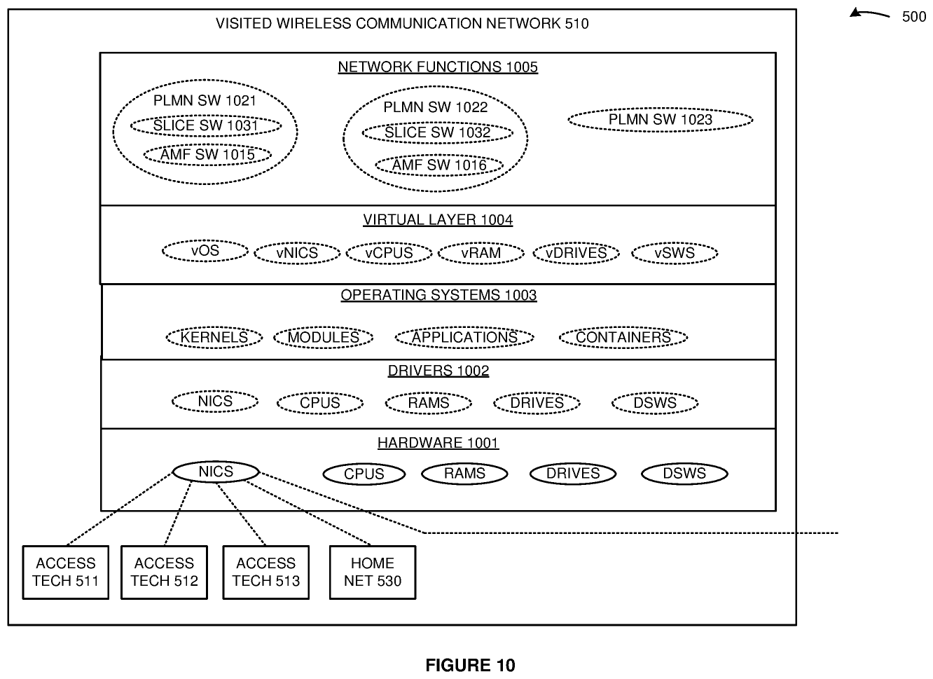

FIG. 10 illustrates exemplary visited wireless communication network 510 in wireless communication system 500 to control roaming wireless UEs 501-503 in visited wireless communication networks 510 and 520. Visited wireless communication network 510 comprises an example of visited wireless communication network 110 and processing circuitry 400, although network 110 and circuitry 400 may differ. Visited wireless communication network 520 could be similar to network 510. Visited wireless communication network 510 includes Network Function Virtualization Infrastructure (NFVI) equipment that comprises hardware 1001, hardware drivers 1002, operating systems 1003, virtual layer 1004, and network functions 1005. Hardware 1001 comprises Network Interface Cards (NICS), CPUS, RAM, Flash/Disk Drives (DRIVES), and Data Switches (DSWS). Hardware drivers 1002 comprise software that is resident in the NICS, CPUS, RAM, DRIVES, and DSWS. Operating systems 1003 comprise kernels, modules, applications, and containers. Virtual layer 1004 comprises virtual Operating Systems (vOS), vNICS, vCPUS, vRAM, vDRIVES, and vSWS. Network Functions 1005 comprises PLMN SW 1021, PLMN SW 1022, and PLMN SW 1023. PLMN SW 1021 comprises AMF SW 1015, slice SW 1031, and other network functions. PLMN SW 1022 comprises AMF SW 1016, slice SW 1032, and other network functions. The NICS in hardware 1001 are coupled to access technologies 511-513, home network 530, and external systems. Hardware 1001 executes hardware drivers 1002, operating systems 1003, virtual layer 1004, and network functions 1005 to form and operate PLMNs 1021-1023. Visited wireless communication network 510 comprises one or more microprocessors and one or more non-transitory machine-readable storage media that store processing instructions that direct visited wireless communication network 510 to exchange data and signaling between access technologies 511-513, home network 530, and external systems as described herein. Visited wireless communication network 510 may be located at a single site or be distributed across multiple geographic locations.

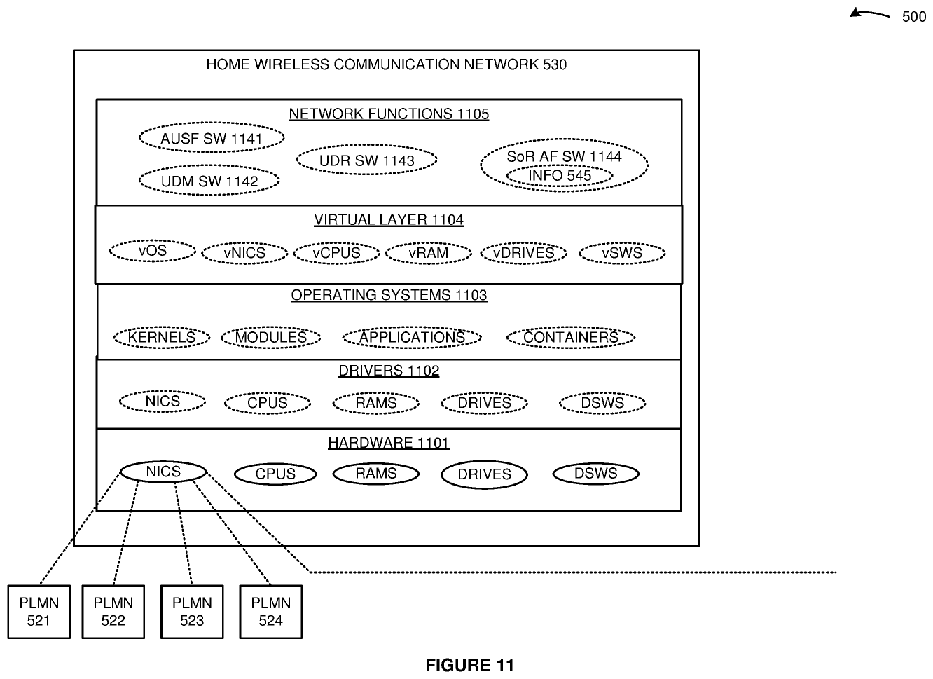

FIG. 11 illustrates exemplary home wireless communication network 530 in wireless communication system 500 to control roaming wireless UEs 501-503 in visited wireless communication networks 510 and 520. Home wireless communication network 530 comprises an example of network controller 102, network database 103, and processing circuitry 400, although controller 102, database 103, and circuitry 400 may differ. Home wireless communication network 530 includes NFVI equipment that comprises hardware 1101, hardware drivers 1102, operating systems 1103, virtual layer 1104, and network functions 1105. Hardware 1101 comprises Network Interface Cards (NICS), CPUS, RAM, Flash/Disk Drives (DRIVES), and Data Switches (DSWS). Hardware drivers 1102 comprise software that is resident in the NICS, CPUS, RAM, DRIVES, and DSWS. Operating systems 1103 comprise kernels, modules, applications, and containers. Virtual layer 1104 comprises virtual Operating Systems (vOS), vNICS, vCPUS, vRAM, vDRIVES, and vSWS. Network Functions 1105 comprise AUSF SW 1141, UDM SW 1142, UDR SW 1143, and SoR AF SW 1144. The NICS in hardware 1001 are coupled to PLMNs 521-524 and external systems. Hardware 1101 executes hardware drivers 1102, operating systems 1103, virtual layer 1104, and network functions 1105 to form and operate AUSF 541, UDR 543, UDR 543, and SoR AF 544 as described herein. Home wireless communication network 530 includes NFVI equipment that comprises one or more microprocessors and one or more non-transitory machine-readable storage media that store processing instructions that direct home wireless communication network 530 to exchange data and signaling between PLMNs 521-524, home network 530, and external systems as described herein. Home wireless communication network 530 may be located at a single site or be distributed across multiple geographic locations.

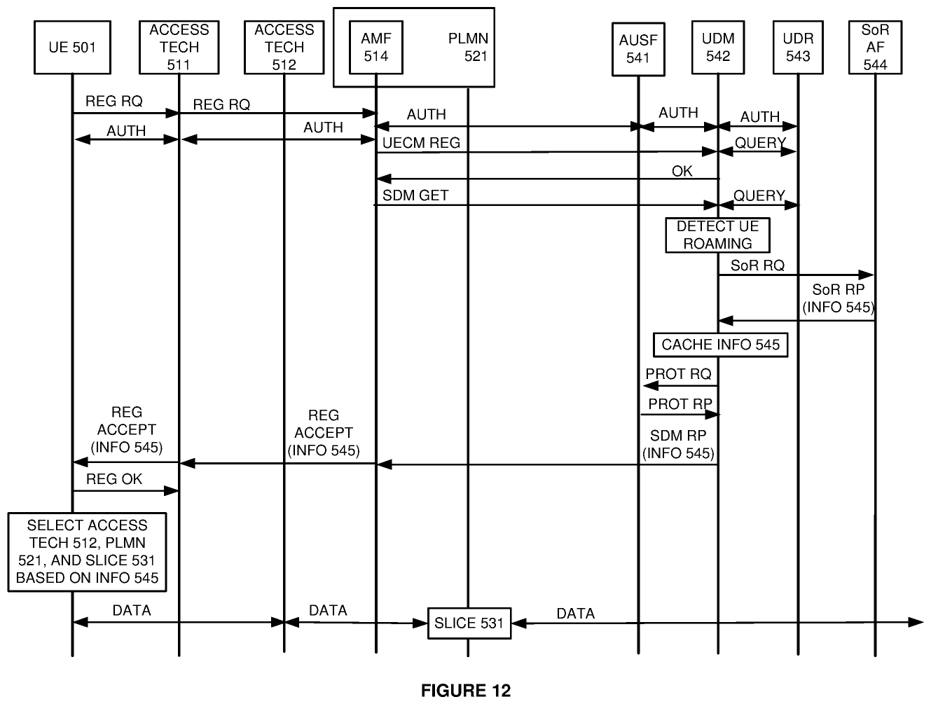

FIG. 12 illustrates an exemplary operation of wireless communication system 500 to control roaming wireless UE 501 in visited wireless communication network 510. The following operation may vary in other examples. UE 501 attaches to access technology 511 (a 5GNR access node). UE 501 transfers a registration request (REG RQ) to AMF 515 over access technology 511. AMF 515 transfers an authentication request to AUSF 541. AUSF 541 transfers the authentication request to UDM 542 which interacts with UDR 543 to obtain and generate authentication data for UE 501. UDM 542 transfers the authentication data to AUSF 541. AUSF 541 transfers the authentication data to AMF 515. AMF 515 and UE 501 perform an authentication session over access technology 511.

After UE authentication, AMF 515 transfers a User Equipment Context Management (UECM) registration to UDM 542. UDM 542 queries UDR 543 for context for UE 501. UDM 542 transfers a UECM registration OK message to AMF 515. AMF 515 transfers a Subscriber Data Management (SDM) GET message to UDM 542. UDM 542 queries UDR 543 for subscriber data for UE 501. UDM 542 transfers a UECM registration OK message to AMF 515. UDM 542 detects that UE 501 is roaming on PLMN 521 in visited network 510 based on the SDM interactions, and in response, transfers Steering-of-Roaming Request (SoR RQ) to SoR AF 544. SoR AF 544 identifies SoR information for PLMN 521 in visited wireless communication network 510 which includes network information 545. SoR AF 544 transfers an SoR Response (RP) to UDM 542 that incudes network information 545. UDM 542 caches network information 545 for PLMN 521 in visited wireless communication network 510.

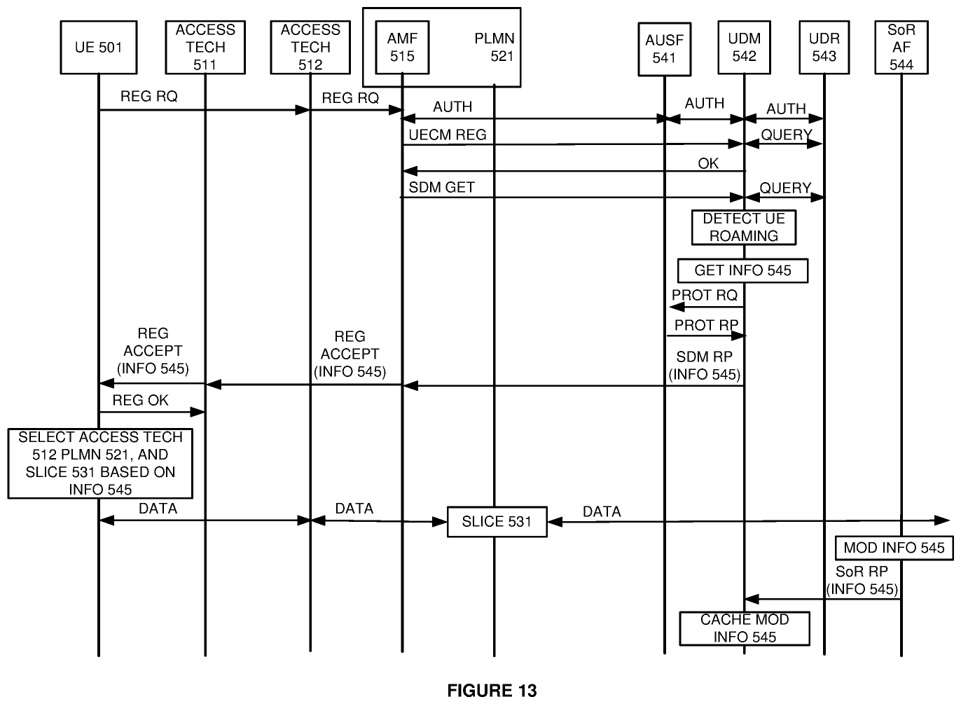

UDM 542 transfers an SoR protection request to AUSF 541, and AUSF 541 returns an SoR protection response. After SoR protection is established, UDM 542 transfers an SoR response to AMF 515 that includes network information 545. AMF 515 transfers a registration accept message that includes network information 545 to UE 501 over access technology 511. Network information 545 has access technology 512 (a WIFI access node), PLMN 521, and slice 531 as the highest priority for UE 501 when visiting PLMN 521 in network 510. UE 501 selects access technology 512, PLMN 521, and slice 531 based on network information 545. UE 501 establishes service and exchanges data over access technology 512, PLMN 521, and slice 531. The operation continues on FIG. 13.

FIG. 13 illustrates an exemplary operation of wireless communication system 500 to control roaming wireless UE 501 in visited wireless communication network 510. The following operation is continued from FIG. 12 may vary in other examples. UE 501 attaches to access technology 512. UE 501 transfers a registration request to AMF 515 over access technology 512. AMF 515 transfers an authentication request to AUSF 541. AUSF 541 transfers the authentication request to UDM 542 which interacts with UDR 543 to obtain and generate authentication data for UE 501. UDM 542 transfers the authentication data to AUSF 541. AUSF 541 transfers the authentication data to AMF 515. AMF 515 and UE 501 perform an authentication session over access technology 512.

After UE authentication, AMF 515 transfers a UECM registration to UDM 542. UDM 542 queries UDR 543 for context for UE 501. UDM 542 transfers a UECM registration OK message to AMF 515. AMF 515 transfers an SDM GET message to UDM 542. UDM 542 queries UDR 543 for subscriber data for UE 501. UDM 542 transfers a UECM registration OK message to AMF 515. UDM 542 detects that UE 501 is roaming on PLMN 521 in network 510 based on the SDM interactions, and in response, retrieves network information 545 from its cache, but does not retrieve network information 545 from SoR AF 544.

UDM 542 transfers an SoR protection request to AUSF 541, and AUSF 541 returns an SoR protection response. After SoR protection is established, UDM 542 transfers an SoR response to AMF 515 that includes network information 545. AMF 515 transfers a registration accept message that includes network information 545 to UE 501 over access technology 512. UE 501 selects access tech 512, PLMN 521, and slice 531 based on network information 545. UE 501 establishes service and exchanges data over access technology 512, PLMN 521, and slice 531.

Subsequently, network information 545 is modified in SoR AF 544. For example, network information 545 may be modified to list PLMN 522 and slice 532 as higher priorities than PLMN 521 and slice 531. In response to the modification, SoR AF 544 transfers modified network information 545 to UDM 542. UDM 542 caches modified network information 545 for visited wireless network 510 in place of old network information 545. As described above for old network information 545, UDM 542 will retrieve modified network information 545 from its cache without accessing SoR AF 544 and will transfer modified network information 545 to UE 501 when it visits PLMN 521 in wireless network 510. UE 501 will use modified network information 545 to select the highest priority access technology, PLMN, and slice-which means UE 501 will switch to PLMN 522 and slice 532 instead of using PLMN 521 and slice 531.

Although not shown on FIGS. 12-13, other roaming UEs on PLMN 521 in visited wireless communication network 510 that are homed to home wireless communication network 530 may use cached network information 545 in a similar manner to UE 501 without requiring UDM 542 to retrieve network information 545 from SoR AF 544. In other visited wireless communication networks, UE 501 may use other cached network lists in a similar manner to network information 545 without requiring UDM 542 to retrieve the other network lists from SOR AF 544.

Advantageously, UDM 542 serves network information 545 without excessive signaling with SoR AF 544 to conserve network resources. Moreover, UDM 542 serves network information 545 which reduces delay and speeds the delivery of wireless network slices 531-532 in visited wireless communication networks 510 and 520.

The wireless communication system circuitry described above comprises computer hardware and software that form special-purpose data communication circuitry system to control roaming wireless UEs in visited wireless communication networks. The computer hardware comprises processing circuitry like CPUs, DSPs, GPUs, transceivers, bus circuitry, and memory. To form these computer hardware structures, semiconductors like silicon or germanium are positively and negatively doped to form transistors. The doping comprises ions like boron or phosphorus that are embedded within the semiconductor material. The transistors and other electronic structures like capacitors and resistors are arranged and metallically connected within the semiconductor to form devices like logic circuitry and storage registers. The logic circuitry and storage registers are arranged to form larger structures like control units, logic units, and Random-Access Memory (RAM). In turn, the control units, logic units, and RAM are metallically connected to form CPUs, DSPs, GPUs, transceivers, bus circuitry, and memory.

In the computer hardware, the control units drive data between the RAM and the logic units, and the logic units operate on the data. The control units also drive interactions with external memory like flash drives, disk drives, and the like. The computer hardware executes machine-level software to control and move data by driving machine-level inputs like voltages and currents to the control units, logic units, and RAM. The machine-level software is typically compiled from higher-level software programs. The higher-level software programs comprise operating systems, utilities, user applications, and the like. Both the higher-level software programs and their compiled machine-level software are stored in memory and retrieved for compilation and execution. On power-up, the computer hardware automatically executes physically-embedded machine-level software that drives the compilation and execution of the other computer software components which then assert control. Due to this automated execution, the presence of the higher-level software in memory physically changes the structure of the computer hardware machines into special-purpose data communication circuitry system to control roaming wireless UEs in visited wireless communication networks.

The above description and associated figures teach the best mode of the invention. The following claims specify the scope of the invention. Note that some aspects of the best mode may not fall within the scope of the invention as specified by the claims. Those skilled in the art will appreciate that the features described above can be combined in various ways to form multiple variations of the invention. Thus, the invention is not limited to the specific embodiments described above, but only by the following claims and their equivalents.

What is claimed is:

1. A method to control a wireless communication device in a visited wireless communication network, the method comprising:
storing a slice indicator for a visited wireless network slice in the visited wireless communication network;
receiving a request from the visited wireless communication network for the wireless communication device; and
in response to receiving the request, retrieving the slice indicator for the visited wireless communication network and transferring the slice indicator to the wireless communication device over the visited wireless communication network, wherein the wireless communication device communicates using the visited wireless network slice in the visited wireless communication network in response to receiving the slice indicator.

2. The method of claim 1 further comprising:
storing a Public Land Mobile Network (PLMN) Identifier (ID) for the visited wireless communication network; and wherein
storing the slice indicator comprises storing the slice indicator in association with the PLMN ID; and
retrieving the slice indicator and transferring the slice indicator to the wireless communication device in response to receiving the request comprises retrieving the slice indicator and transferring the slice indicator to the wireless communication device in response to receiving the PLMN ID in the request.

3. The method of claim 1 further comprising:
storing a user application indicator for the visited wireless communication network; and wherein
storing the slice indicator comprises storing the slice indicator in association with the user application indicator; and
retrieving the slice indicator and transferring the slice indicator to the wireless communication device in response to receiving the request comprises retrieving the slice indicator and transferring the slice indicator to the wireless communication device in response to receiving the user application indicator in the request.

4. The method of claim 1 further comprising:
storing an access technology indicator for the visited wireless communication network; and wherein
storing the slice indicator comprises storing the slice indicator in association with the access technology indicator; and
retrieving the slice indicator and transferring the slice indicator to the wireless communication device in response to receiving the request comprises retrieving the slice indicator and transferring the slice indicator to the wireless communication device in response to receiving the access technology indicator in the request.

5. The method of claim 1 wherein:
storing the slice indicator comprises storing a prioritized slice list that includes the slice indicator and additional slice indicators in a priority order;
retrieving the slice indicator and transferring the slice indicator to the wireless communication device in response to receiving the request comprises retrieving the prioritized slice list that includes the slice indicator and the additional slice indicators in the priority order and transferring the prioritized slice list to the wireless communication device in response to receiving the request.

6. The method of claim 1 wherein the slice indicator comprises a slice type.

7. The method of claim 1 wherein:
receiving the request from the visited wireless communication network for the wireless communication device comprises receiving a Subscriber Data Management GET message from the visited wireless communication network for the wireless communication device; and
retrieving the slice indicator for the visited wireless communication network and transferring the slice indicator to the wireless communication device over the visited wireless communication network in response to receiving the request comprises retrieving the slice indicator for the visited wireless communication network and transferring the slice indicator to the wireless communication device over the visited wireless communication network in response to receiving the Subscriber Data Management GET message.

8. A method to control a wireless communication device in a visited Public Land Mobile Network (PLMN), the method comprising:
a Steering-of-Roaming Application Function (SoR-AF) storing a slice indicator for a visited wireless network slice in the visited PLMN;
a Unified Data Management (UDM) receiving a request from the visited PLMN for the wireless communication device; and
in response to receiving the request, the UDM retrieving the slice indicator for the visited PLMN from the SoR-AF and transferring the slice indicator to the wireless communication device over the visited PLMN, wherein the wireless communication device communicates using the visited wireless network slice in the visited PLMN in response to receiving the slice indicator.

9. The method of claim 8 further comprising:
the UDM caching the slice indicator for the visited PLMN in a UDM memory; and
in response to receiving another request, the UDM retrieving the slice indicator for the visited PLMN from the UDM memory and transferring the slice indicator to the wireless communication device over the visited PLMN.

10. The method of claim 8 further comprising:
the SoR-AF modifying the slice indicator for the visited PLMN, and in response, transferring the modified slice indicator for the visited PLMN to the UDM;
the UDM caching the modified slice indicator for the visited PLMN in the UDM memory; and
in response to receiving another request, the UDM retrieving the modified slice indicator for the visited PLMN from the UDM memory and transferring the modified slice indicator to the wireless communication device over the visited PLMN, wherein the wireless communication device communicates using a different visited wireless network slice in the visited PLMN in response to receiving the modified slice indicator.

11. The method of claim 8 further comprising:
the SoR-AF storing a user application indicator for the visited PLMN; and wherein
the SoR-AF storing the slice indicator comprises storing the slice indicator in association with the user application indicator; and
the UDM retrieving the slice indicator and transferring the slice indicator to the wireless communication device in response to receiving the request comprises retrieving the slice indicator and transferring the slice indicator to the wireless communication device in response to receiving the user application indicator in the request.

12. The method of claim 8 further comprising:
the SoR-AF storing an access technology indicator for the visited PLMN; and wherein
the SoR-AF storing the slice indicator comprises storing the slice indicator in association with the access technology indicator; and
the UDM retrieving the slice indicator and transferring the slice indicator to the wireless communication device in response to receiving the request comprises retrieving the slice indicator and transferring the slice indicator to the wireless communication device in response to receiving the access technology indicator in the request.

13. The method of claim 8 wherein:
the SoR-AF storing the slice indicator comprises storing a prioritized slice list that includes the slice indicator and additional slice indicators in a priority order;
the UDM retrieving the slice indicator and transferring the slice indicator to the wireless communication device in response to receiving the request comprises retrieving the prioritized slice list that includes the slice indicator and the additional slice indicators in the priority order and transferring the prioritized slice list to the wireless communication device in response to receiving the request.

14. A wireless communication system to control a wireless communication device in a visited wireless communication network, the wireless communication system comprising:
a network database store a slice indicator for a visited wireless network slice in the visited wireless communication network;
a network controller to receive a request from the visited wireless communication network for the wireless communication device; and
in response to receiving the request, the network controller to retrieve the slice indicator for the visited wireless communication network from the network database and transfer the slice indicator to the wireless communication device over the visited wireless communication network, wherein the wireless communication device is to communicate with the visited wireless network slice in the visited wireless communication network in response to receiving the slice indicator.

15. The wireless communication system of claim 14 further comprising:
the network database to store a Public Land Mobile Network (PLMN) Identifier (ID) for the visited wireless communication network; and wherein
the network database is to store the slice indicator in association with the PLMN ID; and
the network controller is to retrieve the slice indicator and transfer the slice indicator to the wireless communication device in response to receiving the PLMN ID in the request.

16. The wireless communication system of claim 14 further comprising:
the network database to store a user application indicator for the visited wireless communication network; and wherein
the network database is to store the slice indicator in association with the user application indicator; and
the network controller is to retrieve the slice indicator and transfer the slice indicator to the wireless communication device in response to receiving the user application indicator in the request.

17. The wireless communication system of claim 14 further comprising:
the network database to store an access technology indicator for the visited wireless communication network; and wherein
the network database is to store the slice indicator in association with the access technology indicator; and
the network controller is to retrieve the slice indicator and transfer the slice indicator to the wireless communication device in response to receiving the access technology indicator in the request.

18. The wireless communication system of claim 14 wherein:
the network database is to store a prioritized slice list that includes the slice indicator and additional slice indicators in a priority order;
the network controller is to retrieve the prioritized slice list that includes the slice indicator and the additional slice indicators in the priority order and transfer the prioritized slice list to the wireless communication device in response to receiving the request.

19. The wireless communication system of claim 14 wherein the slice indicator comprises a slice type.

20. The wireless communication system of claim 14 wherein:
the network controller is to receive a Subscriber Data Management GET message from the visited wireless communication network for the wireless communication device to receive the request; and
the network controller is to retrieve the slice indicator for the visited wireless communication network and transfer the slice indicator to the wireless communication device over the visited wireless communication network in response to receiving the Subscriber Data Management GET message.
